(19) United States
(12) Patent Application Publication
(10) Pub. No.: US 2014/0114445 A1
(43) Pub. Date: Apr. 24, 2014

(54) INTERFACE SYSTEM FOR MAN-MACHINE INTERACTION

(71) Applicants: Marco Gaudina, Genova (IT); Andrea Brogni, Pontedera (IT); Alessio Margan, Torriglia (IT); Stefano Cordasco, Genova (IT); Gianluca Pane, Ivrea (IT); Darwin G. Caldwell, Serra Ricco' (IT)

(72) Inventors: Marco Gaudina, Genova (IT); Andrea Brogni, Pontedera (IT); Alessio Margan, Torriglia (IT); Stefano Cordasco, Genova (IT); Gianluca Pane, Ivrea (IT); Darwin G. Caldwell, Serra Ricco' (IT)

(73) Assignee: FONDAZIONE ISTITUTO ITALIANO DI TECNOLOGIA, Genova (IT)

(21) Appl. No.: 14/125,848

(22) PCT Filed: Jun. 13, 2012
(86) PCT No.: PCT/IB2012/052972

§ 371 Date: Dec. 12, 2013

(30) Foreign Application Priority Data
Jun. 16, 2011 (IT) TO2011A000530

(51) Int. Cl. G05B 15/02

(52) U.S. Cl. CPC G05B 15/02
USPC 700/83

(57) ABSTRACT

An interface system (10) for man-machine interaction includes a sensor and actuator arrangement (12) wearable by or coupled to the body (B) of a user. A management unit (14) exchanges data with a control application resident on a remote processing system (PS), to transmit data to the application, indicative of the position and movements of the user in a physical environment, and to transmit sensations to the user, in at least one point of the body of the user, indicative of the interaction with an operating environment. The sensors and actuators are supported by operating modules (16), interfacing on at least one communication channel through respective pairs of input and output communication ports. The operating modules are provided with interconnection devices (18) in such a way as to be assembled to each other into a planar arrangement and/or a stacked arrangement.

The present invention relates to an interface system for man-machine interaction, comprising
a sensor and actuator arrangement wearable by or couplable to the body of a user; and
a management unit managing said sensor and actuator arrangement, and provided for exchanging data with a control application resident on a remote processing system, in such a way as to transmit data to said application, indicative of movements of the user in a physical environment, and in such a way as to transmit sensations to the user, localized in at least one point of the body of the user, indicative of the interaction of the user with an operating environment generated or at least controlled by said processing system;
in which said sensor and actuator arrangement comprises at least one network of sensors, which are adapted to collect measurement data indicative of movements of the sensors in said physical environment and to supply said measurement data to the control application through the management unit, and at least one network of actuators, which are adapted to induce in said at least one point of the body of the user at least one sensation indicative of the interaction of the user in said operating environment, on the basis of instruction data from the control application through the management unit.

Such a system is described for example in the publication EP 1 533 678, relating to a haptic feedback system for game and entertainment environments. Such known system provides for actuators and sensors applied on an item of clothing or other accessory wearable by a user. The possibilities of use of such a system are dictated by the specific positioning of the network of actuators and sensors on the item of clothing or the accessory.

An object of the invention is to provide an interface system that allows obtaining a higher versatility, flexibility, and adaptability to the conditions of use, compared to the known systems.

In view of such object, it is the subject matter of the invention a system of the type initially defined, in which said sensors and actuators are supported by a plurality of operating modules, facing on at least one communication channel through respective pairs of input and output communication ports and being operatively connected to said management unit through said communication channel, in which said operating modules are provided with interconnecting means in such a way as that said operating modules are assemblable to each other into a planar arrangement and/or a stacked arrangement.

According to such idea of solution, the operating modules supporting the sensors and actuators can be assembled as desired to obtain aggregates of operating modules, or “molecules”, capable of collecting a series of different measurement data in determined detection points of the body of the user, and/or of providing the user with a combination of tactile stimuli, or other stimuli, in a localized manner in determined stimulation points of the body of the user.

Advantageously, according to a preferred embodiment of the invention, the operation of the sensors and actuators is configurable by the user by a processing system and through said management unit, on the basis of the positioning of said sensors and actuators on the body of the user and on the basis of a desired interaction of the user with the operating environment generated or at least controlled by the processing system.

Furthermore, it is the object of the invention a system for man-machine interaction, comprising
a processing system for executing a control application, and
an interface comprising
   a sensor and actuator arrangement wearable by or couplable to the body of a user; and
   a management unit managing said sensor and actuator arrangement, and provided for exchanging data with said control application, in such a way as to transmit data to said application, indicative of movements of the user in a physical environment, and in such a way as to transmit sensations to the user, localized in at least one point of the body of the user, indicative of the interaction of the user with an operating environment generated or at least controlled by said processing system;
in which said sensor and actuator arrangement comprises at least one network of sensors, which are adapted to collect measurement data indicative of movements of the sensors in said physical environment and to supply said measurement data to the control application through the management unit, and at least one network of actuators, which are adapted to induce at least one sensation indicative of the interaction of the subject in said virtual reality, on the basis of instruction data from the control application through the management unit;
in which said sensors and actuators are supported by a plurality of operating modules, facing on at least one communication channel through respective pairs of input and output communication ports and being operatively connected to said management unit through said communication channel, in which said operating modules are provided with interconnecting means in such a way as that said operating modules are assemblable to each other into a planar arrangement and/or a stacked arrangement.

Further characteristics and advantages of the system according to the invention will be apparent from the following detailed description, given with reference to the annexed drawings, provided by way of non-limiting example only, in which:

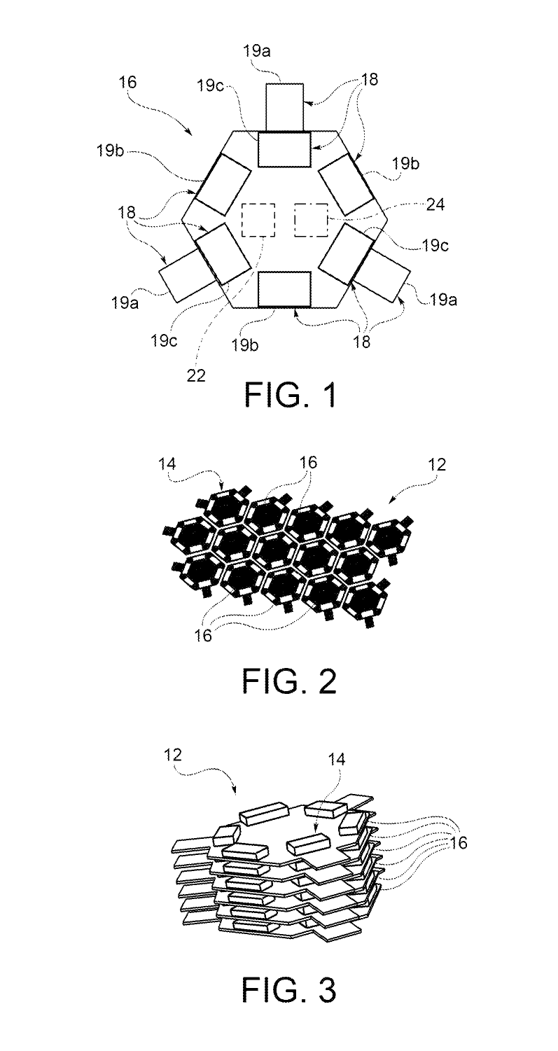

FIG. 1 is a schematic representation in plan view of an operating module of an interface system according to the invention;

FIGS. 2 and 3 are schematic representations of a plurality of operating modules as that in FIG. 1, assembled in two different configurations; and

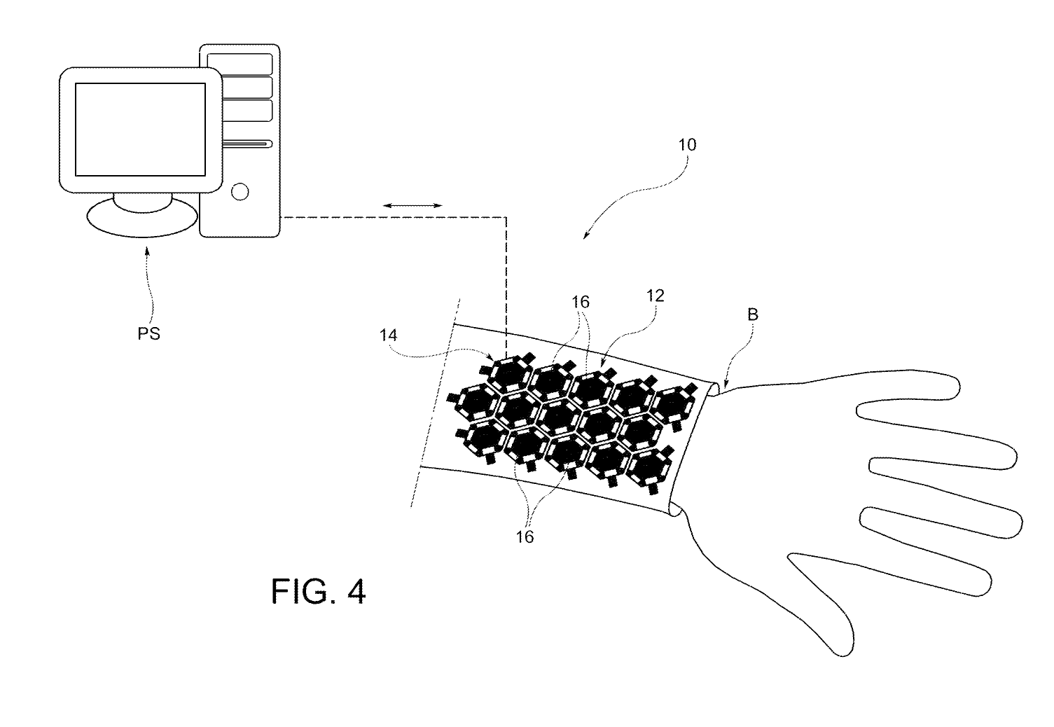

FIG. 4 is a schematic representation of a system for man-machine interaction according to the invention.

With reference to the Figures, and in particular to FIG. 4, an interface system for man-machine interaction is generally indicated with 10.

Such system 10 comprises a sensor and actuator arrangement 12 wearable by or couplable to the body B of a user. Such arrangement 12 can, for example, be secured to an item of clothing, to a wearable accessories, to a tool, and so on.

The system 10 further comprises a management unit 14 managing the sensor and actuator arrangement 12, and provided for exchanging data with a control application resident on a remote processing system PS, in such a way as to transmit data to the application indicative of movements of the user in a physical environment, and in such a way as to transmit sensations to the user, localized in at least one point of the body of the user, indicative of the interaction of the user with an operating environment generated or at least controlled by the processing system PS.

According to an embodiment of the invention, such operating environment can be composed of a virtual reality generated by the processing system. According to another embodiment, the above-mentioned operating environment can be composed of a software application, for example a CAD or CAM application. According to a further embodiment, the operating environment can be composed of a physical environment controlled by the processing system, as in the case of the control of robotic devices.

The sensor and actuator arrangement comprises at least one network of sensors, which are adapted to collect measurement data indicative of movements of the sensors in the physical environment and to supply such measurement data to the control application through the management unit 14, and at least one network of actuators, which are adapted to induce at least one sensation indicative of the interaction of the subject in the virtual reality, on the basis of instruction data from the control application through the management unit 14.

The above-mentioned sensors and actuators are supported by a plurality of operating modules 16, one of which is represented individually and in a schematic manner in FIG. 1. Such operating modules 16 are facing on at least one communication channel through respective pairs of input and output communication ports and are operatively connected to the management unit 14 through the above-mentioned communication channel. Such communication channel can be for example a communication bus, or a mesh wireless network.

With reference to FIG. 1, each operating module 16 is composed of a board element having the shape of a regular polygon, in particular a hexagonal-shaped printed circuit board (PCB). The operating modules 16 are provided with mechanical interconnecting means 18 in such a way as that such operating modules 16 are assemblable to each other according to a planar arrangement, as illustrated in FIGS. 2 and 4, and/or a stacked arrangement, as illustrated in FIG. 3.

Each of the board elements 16 has a plurality of electrical connectors for side connection 19a, 19b, respectively male and female, which are alternatively arranged on the sides of the polygonal perimeter of the board element 16.

Furthermore, each of the board elements 16 has (at least) one pair of male and female electrical connectors of vertical connection 19c (the female connector non is visible in the Figure), respectively arranged on opposite faces of the board element 16.

Advantageously, the interconnecting means 18 are provided by the same electrical connectors 19a, 19b, 19c of the board element. According to alternative implementation modes, such interconnecting means could be constituted by devices independent from the electrical connectors.

To the aims of the present invention, by “operating modules assemblable to each other” is meant that the interconnecting means are configured so as to allow the direct physical interconnection between operating modules, when this is required by the cases. Such interconnection can be obtained for example with mechanical means, such as snap coupling devices, or with magnetic means. Of course, according to the needs, such interconnecting means can be employed also in cooperation with mediator members, for example, hoses, to implement a mediated physical interconnection between the modules.

From a circuital point of view, each operating module is supported by a corresponding microcontroller. The inventors made prototypes of the operating modules with 6-pin lateral electrical connectors, with the following configuration at the PIN level:
Vcc
GND
I2C SDA (data)
I2C SCL (clock)
Tx UART
Rx UART

Instead, 10-pin vertical connectors have been used, with the same configuration of the lateral ones, but with the addition of 4 channels to allow the flash of the bootloader (MISO, MOSI, RESET, CLK), but which can be used also to upload a program.

As stated before, the sensors and actuators of the interface system are supported by the operating modules 16. In FIG. 1, an operating module is represented, supporting both a sensor, indicated with 22, and an actuator, indicated with 24. It shall be apparent that each of the operating modules 16 can be implemented as a detection unit supporting only one or more sensors, or as an actuation unit supporting only one or more actuators.

At the prototype level, the inventors have produced the following hardware units.

### Management Unit, or Master Unit

Such unit is represented in FIG. 4, and indicated with 14. From a structural point of view, it is also advantageously implemented as an operating module in a shape similar to that of the operating modules 16 supporting the sensors and the actuators, and it is provided with interconnecting mechanical means to implement with such operating modules planar or vertical interconnection configurations. In the prototype produced by the inventors, such unit is distinguished from the other modules in the presence of a Multiplexer Bus and in that its connectors are separated in distinct BUS I2C, useful to the connection of up to 127 units per BUS. As indicated above, the Master unit attends to the management of the entire system as regards the data communication between the operating modules 16 and the remote processing system PS.

### Serial Communication Unit

Such unit, not represented in the Figures, is advantageously implemented from a structural point of view as an operating module having a shape similar to that of the operating modules 16 supporting the sensors and the actuators, and it is provided with interconnecting means to implement planar or vertical interconnection configurations with such operating modules. This unit allows the communication via serial port of the interface system 10 with the processing system PS. At the prototype level, such unit has been implemented with a USB interface.

### Wireless Communication Unit

Such unit, not represented in the Figures, is advantageously implemented from a structural point of view as an operating module having a shape similar to that of the operating modules 16 supporting the sensors and the actuators, and it is provided with interconnecting means to implement planar or vertical interconnection configurations with such operating modules. Such unit allows the wireless communication of the interface system 10 with the processing system PS. At the prototype level, such unit has been implemented with a ZigBee device.

Of course, further types of communication units can be provided, for example, with WiFi, Bluetooth, or with GPRS modem devices.

### Actuation Unit

Such unit, generally indicated with 16 in the Figures, is provided with one or more actuators to induce at least one sensation indicative of the interaction of the subject in the virtual reality generated by the processing system, on the basis of instruction data from the management unit 14. At the prototype level, such a unit has been implemented by two vibration motors, a Peltier cell, and a continuous current motor, and has been provided with two H bridges for the control of two PWM (Pulse Width Modulation) signals.

Of course, also other types of actuators can be provided, for example, fluidic actuators. Other actuation devices can be devices releasing liquid or other effects, such as smoke or return force.

### Hole Unit

Such unit is an actuation unit as that described before, but provided with a central hole allowing the movement of mechanical parts, such as a cursor for tactile feedback.

### Detection Unit

Such unit, generally indicated with 16 in the Figures, is provided with one or more sensors for collecting measurement data indicative of movements of the sensors in the physical environment and to supply such measurement data to the management unit 14. At the prototype level, such a unit has been implemented by an accelerometer, providing in output the orientation vector in the three-dimensional space; the position in the space of the operating modules is obtained by an external tracking system, in particular of the optical type, managed by the processing system PS.

Of course, further types of sensors can be provided, such as, for example, temperature sencors, magnetic field, moisture, strength, flexure sensors, or light sensors. For the spatial localization of the operating modules, alternatively to the tracking system, it is possible to provide such modules with corresponding positioning units.

### Supply Unit

Such unit provides for the power supply of the interface system. At the prototype level, such unit has been implemented with a seat for the insertion of batteries.

Of course, other supply means can be provided, for example, a connection to an external electric network, or an independent source, such as a photovoltaic source.

Besides the units listed above, there may be units with other functions, such as, for example, mass memory units, or non-tactile input/output units provided with microphone, micro-speaker, mini-display, or micro-camera.

Furthermore, different functions can be integrated in the same unit/operating module; for example, in the management/Master unit 14, a wireless communication device can be integrated. In this case, it is possible to omit a dedicated wireless communication unit. As a further example, the management/Master unit 14 can also be provided with an actuator and/or a sensor.

Multiple Master units can also be present, each of which manages its own networks of actuators and sensors; in this case, it is possible to provide for a management/supermaster unit with routing functions. In this regard, it is also possible to provide for a network formed only by Master units, each of which being provided with its own actuators and/or sensors.

In the prototype system implemented by the inventors, each unit can be programmed, and it is managed by a real time operative system allowing the interface system to perform more tasks simultaneously.

Within the Master unit, the following tasks have been configured:
communication task, i.e., management of the communications via serial port and I2C;
data polling task, i.e., a cyclic query of all the units to get information about their state.

The following tasks are present in the prototype actuation unit:
temperature control task—a PID controller of a basic type has been implemented, for the management of the temperature in relation to a preset SetPoint;
position reaching task—this task is dedicated to the management of the position of the DC motor, by a Look-Up Table and in open loop.

The following tasks are present in the prototype detection unit:
orientation calculation task—once the analogic values of the accelerometer have been acquired, the orientation vector is calculated.

In general, it is possible to create specific tasks for each unit, until totally filling the available RAM memory.

In the prototype system described above, the communication between interface system 10 and processing system PS mainly takes place in two modes: in a wired serial or a wireless mode. Instead, the inter-unit communication occurs via a I2C protocol, and each unit is assigned a unique address. The data communication takes place by using the following data protocol:

$ CommandType | UnitAddress | CommandValue #

Single commands, or Macros of commands can be managed, in order to perform operations in real time that are optionally mutually dependant (for example in the case of a complex set of sensorial stimuli to be sent to the user).

As stated before, the operating modules are programmable, therefore the operation of the sensors and the actuators is configurable and re-configurable by the user by the processing system PS and through the management unit 14, on the basis of the desired placement of the sensors and the actuators on the body of the user and on the basis of a desired interaction of the user with the virtual reality generated by the processing system.

The configuration and re-configuration of the operating modules can occur by manually programming them by the use of a compiler, or by an optical recognition procedure or RFID. The optical recognition procedure or RFID is preferable, since it does not require any particular programming skill from the user.

An example of an optical recognition procedure is as follows.

The user displays an operating module 16 to a camera of the processing system PS and consequently selects the use mode, by positioning the operating module on the desired portion of the body. If, for example, a unit for the generation of a tactile stimulus has been used, which is located on the forearm, a software application simulating cubes exiting from the screen of the processing system will lead the operating module to generate a tactile stimulus when a cube enters in virtual contact with the user's arm.

Another example is as follows.

The user assembles the Master unit 14 with multiple operating modules 16 suitable to generate contact sensations, thermal stimulus, and vibration, to simulate the use of a fire-arm. Then the user displays the set of such modules, or molecule, to a camera, and locates it on a finger through an anchoring system. Such sequence can be repeated for each desired finger. At this point, the user interacts with the characteristics of the virtual object, in this case the fire-arm. By grasping the virtual fire-arm, the user will have a contact sensation; on the other hand, by pressing the virtual trigger, the user will have a sensation of vibration and heat, in preset operative points depending on the position of the operating modules responsible for such sensations.

1. An interface system for man-machine interaction, comprising:
a sensor and actuator arrangement wearable by or couplable to the body of a user; and
at least one management unit managing said sensor and actuator arrangement and providing for exchanging data with a control application resident on a remote processing system to transmit data to said application, indicative of movements of the user in a physical environment, and to transmit sensations to the user, localized in at least one point of the body of the user and indicative of the interaction of the user with an operating environment generated or at least controlled by said processing system;
wherein said sensor and actuator arrangement comprises at least one network of sensors which are adapted to collect measurement data indicative of movements of the sensors in said physical environment and to supply said measurement data to the control application through the management unit, and at least one network of actuators which are adapted to induce at least one sensation indicative of the interaction of the user with said operating environment in said at least one point of the body of the user, on the basis of instruction data from the control application, received by the actuators through the management unit;
wherein said sensors and actuators are supported by a plurality of operating modules interfacing on at least one communication channel through respective pairs of input and output communication ports and being operatively connected to said management unit through said communication channel, wherein said operating modules are provided with interconnectors so that said operating modules are assemblable to each other into a planar arrangement and/or a stacked arrangement.

2. A system according to claim 1, wherein said operating modules comprise board elements, and said interconnectors are arranged on one or more electrical connectors provided on each of said board elements.

3. A system according to claim 1, wherein said operating modules comprise regular-polygon shaped board elements, each of said board elements having a plurality of male and female electrical connectors for side connection, which are alternatively arranged on the sides of the polygonal perimeter of the board element.

4. A system according to claim 1, wherein each of said board elements has at least one pair of male and female electrical connectors for vertical connection, respectively arranged on opposite faces of the board elements.

5. A system for man-machine interaction, comprising
a processing system for executing a control application, and
an interface comprising:
a sensor and actuator arrangement wearable by or couplable to the body of a user; and
at least one management unit managing said sensor and actuator arrangement and providing for exchanging data with said control application, to transmit data to said application, indicative of movements of the user in a physical environment, and to transmit sensations to the user, localized in at least one point of the body of the user and indicative of the interaction of the user with an operating environment generated or at least controlled by said processing system;
wherein said sensor and actuator arrangement comprises at least one network of sensors which are adapted to collect measurement data indicative of movements of the sensors in said physical environment and to supply said measurement data to the control application through the management unit, and at least one network of actuators which are adapted to induce at least one sensation indicative of the interaction of the user with said operating environment in said at least one point of the body of the user, on the basis of instruction data from the control application, received by the actuators through the management unit;
wherein said sensors and actuators are supported by a plurality of operating modules interfacing on at least one communication channel through respective pairs of input and output communication ports and being operatively connected to said management unit through said communication channel, wherein said operating modules are provided with interconnecting means (18) for assembling said operating modules to each other into a planar arrangement and/or a stacked arrangement.

6. A system according to claim 5, wherein said operating modules comprise board elements, and said interconnecting means are arranged on one or more electrical connectors provided on each of said board elements.

7. A system according to claim 5, wherein said operating modules comprise regular-polygon shaped board elements, each of said board elements having a plurality of male and female electrical connectors for side connection, alternatively arranged on the sides of the polygonal perimeter of each of the board elements.

8. A system according to claim 5, wherein each of said board elements has at least one pair of male and female electrical connectors for vertical connection, respectively arranged on opposite faces of the board elements.

9. A system according to claim 5, wherein operation of said sensors and actuators is configurable by the user by said processing system and through said management unit, on the basis of a desired placement of said sensors and actuators on the body of the user and on the basis of a desired interaction of the user with the operating environment generated or at least controlled by the processing system.
